(19) United States
(12) Patent Application Publication
(10) Pub. No.: US 2014/0351953 A1
(43) Pub. Date: Nov. 27, 2014

(54) PERMISSIONS FOR EXPLOITABLE CONTENT

(71) Applicant: Rajesh Bhatia, Bangalore Karnataka (IN)

(72) Inventor: Rajesh Bhatia, Bangalore Karnataka (IN)

(21) Appl. No.: 14/373,008

(22) PCT Filed: Jan. 27, 2012
(86) PCT No.: PCT/IN2012/000060

§ 371 Date: Jul. 17, 2014

(51) Int. Cl. G06F 21/62; H04B 5/00

(52) U.S. Cl. CPC G06F 21/6218; H04B 5/0031
USPC 726/27

(57) ABSTRACT

Examples described herein facilitate managing exploitation permissions for exploitable content files relative to an exploitation entity.

### BACKGROUND

Consumer devices such as tablets, laptops, mobile phones, netbooks and printers are growing at an exponential pace. Increasingly, many such devices have access to application ecosystems that allow content to be downloaded and exploited on a compatible device.

### BRIEF DESCRIPTION OF DRAWINGS

The following description includes discussion of figures having illustrations given by way of example of implementations of embodiments of the invention. The drawings should be understood by way of example, not by way of limitation. As used herein, references to one or more “embodiments” are to be understood as describing a particular feature, structure, or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive,

FIG. 1 is a block diagram illustrating a system according to various embodiments.

FIG. 2 is a block diagram illustrating a system according to various embodiments.

FIG. 3 is a flow diagram of operation in a system according to various embodiments.

FIG. 4 is a flow diagram of operation in a system according to various embodiments.

### DETAILED DESCRIPTION

Embodiments described herein associate access rights with content available from a content management and/or distribution system. As used herein, an exploitation device is a computing device capable of exploiting digital content for human consumption (e.g., playing audio and/or video files, displaying text and/or images, printing text and/or images, etc.). As described herein, exploitation devices check whether a user is authorized to exploit (e.g., view or print) content before it is actually exploited on the device.

In various embodiments, an exploitable content file includes an embedded identifier that points to a location where exploitation permissions for the content are stored at a remote location (e.g., on a network server). Thus, when a user attempts to access exploitable content, the exploitation device checks the exploitation permissions corresponding to the identifier (e.g., URL or Uniform Resource Locator) and grants access to the content if the appropriate permissions exist. Further details corresponding to various embodiments are described below.

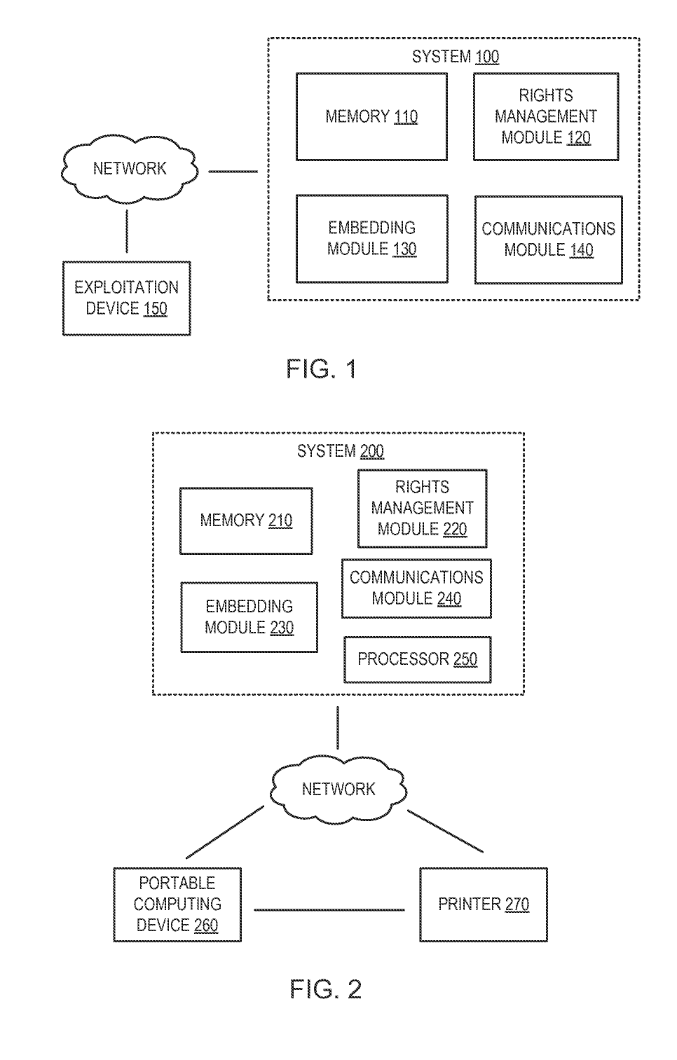

FIG. 1 is a block diagram illustrating a system according to various embodiments. FIG. 1 includes particular components, modules, etc. according to various embodiments. However, in different embodiments, more, fewer, and/or other components, modules, arrangements of components/modules, etc. may be used according to the teachings described herein. In addition, various components, modules, etc. described herein may be implemented as one or more software modules, hardware modules, special-purpose hardware (e.g., application specific hardware, application specific integrated circuits (ASICs), embedded controllers, hardwired circuitry, etc.), or some combination of these, As shown by the dotted line, the modules of system 100 may be incorporated into a single physical device or they may be distributed across multiple physical devices, for example, over a network.

A memory 110 stores an exploitable content file. As used herein, an exploitable content file refers to a content file capable of exploitation on an exploitation device. For example, a document file that can be displayed and/or printed for a human to read may be an exploitable content file. Audio files (e.g., MP3 files) and video files (e.g., .AVI files, .MWV files, etc.) may also be examples of exploitable content files. While exploitable content files may be compatible across multiple devices, it is not necessary that an exploitable content file be compatible across all types of exploitation devices. For example, an audio file may be an exploitation content file even though it may not be printed (i.e., exploited) on a printer (which is an example of exploitation device).

Rights management module 120 manages exploitation permissions for the exploitable content file specific to an exploitation entity. While an exploitation entity may be a single device, it could also be a class of exploitation devices (e.g., a class of printers or class of tablets, etc.). In various embodiments, an exploitation entity may be defined as a user or a set of one or more exploitation devices associated with (e.g., registered to) the user.

An exploitable content file has a permissions identifier relative to an exploitation entity. Thus, when a user seeks to obtain exploitable content from system 100, embedding module 130 embeds the identifier into an exploitation copy (i.e., a copy to be exploited by a user on an exploitation device) of the exploitable content file. In various embodiments, the embedded identifier indicates a network address for ascertaining the exploitation permissions for the particular exploitation copy. For example, embedding module 130 might embed a URL (Uniform Resource Locator) into a document. The URL points to a network location that contains the exploitation permissions for the document relative to the exploitation entity.

In an example, a user requesting a document from system 100 might have a subscription to a service where the user's exploitation permissions include printing permissions for all content hosted by system 100. Accordingly, embedding module 130 embeds a URL into an exploitation copy of the requested document and communications module 140 provides the exploitation copy to an exploitation device 150 that allows the user to print the requested document. In various embodiments, exploitation device 150 accesses the URL embedded in the document before exploiting (in this case printing) the content to determine whether the exploitation permissions associated with the URL permit the exploitation. If authorized based on the permissions, exploitation device 150 exploits (e.g. prints) the content.

In managing exploitation permissions, rights management module 120 may upgrade the exploitation permission for an exploitable content file relative to an exploitation entity in view of an authorized request. For example, a user may have limited permissions to print a particular document based on the user's purchase of the particular content. However, if the user requests an upgrade to the exploitation permissions and rights management module 120 obtains authorization for the request (e.g., via verified payment for the upgrade), then rights management module 120 handles the upgrade. In various embodiments, this upgrade might include updating the permissions information at the network location of the embedded URL for each content file affected by the upgrade. In other words, if the user upgrades permissions for a particular document, the permissions stored at the URL embedded into that particular document might be updated to reflect the upgrade. For example, the upgrade might allow the document to be viewed on a mobile device in addition to printing the document (or vice versa). Exploitation permission upgrades could be content-specific, exploitation entity specific (e.g., a single device, a class of devices, a group of users, a single user, etc.) or some combination of these.

In some embodiments, exploitation permission upgrades may involve providing the same content in a different format compatible with desired use. For example, if a user initially obtains a PDF (Portable Document Format) document for viewing on a mobile device and then upgrades the permissions to allow printing of the document, communications module 140 might provide an exploitation copy of the document (with embedded identifier) to the printer in a print-ready format (e.g. PCL or Printer Control Language).

FIG. 2 is a block diagram illustrating a system according to various embodiments. FIG. 2 includes particular components, modules, etc. according to various embodiments. However, in different embodiments, more, fewer, and/or other components, modules, arrangements of components/modules, etc. may be used according to the teachings described herein. In addition, various components, modules, etc. described herein may be implemented as one or more software modules, hardware modules, special-purpose hardware (e.g., application specific hardware, application specific integrated circuits (ASICs), embedded controllers, hardwired circuitry, etc.), or some combination of these. Various modules and/or components illustrated in FIG. 2 may be implemented as a non-transitory computer-readable storage medium containing instructions executed by a processor (e.g., processor 250) and stored in a memory (e.g., memory 210) for performing the operations and functions discussed herein.

In the example system illustrated in FIG. 2, the modules and components of system 200 may be integrated into a single physical computing device (e.g. server) or they may be physically distributed among multiple computing devices (e.g. servers) connected, for example, over a network.

A memory 210 stores an exploitable content file. Exploitable content files could be uploaded to system 200 by a content provider, a content owner, a business, a consumer, or other suitable entity. Exploitable content files may be designated with default exploitation permissions defined, at least in part, by the entity uploading the content. The uploading entity may also select or define an upgrade scheme for upgrading exploitation permissions for some or all uploaded content.

Rights management module 220 manages exploitation permissions for the exploitable content file specific to an exploitation entity. While an exploitation entity may be a single device, it could also be a class of exploitation devices (e.g., a class of printers or class of tablets, etc.). An exploitation entity may alternatively be a user or a set of one or more exploitation devices associated with (e.g., registered to) the user.

In an example, a user of portable computing device 260 (e.g., a smartphone) browses a website or traverses a device app to find and download (e.g. via purchase) exploitable content (e.g. an article to read). The download may include the rights/permissions to display the content on portable computing device 260. In connection with the user request, the requested content is retrieved from memory 210 and embedding module 230 embeds a URL into the content. The URL links to a description of the permissions tied to this particular copy of the requested content. In other words, permissions for exploiting the particular copy of the requested content are determined based on the information stored at the location indicated by the URL. This means that permissions can be changed (e.g., upgraded) even after a particular copy of the requested content has been downloaded. Thus, rather than having to download a different copy of a particular content item for each different type of exploitation, content and service providers can provide more granularity and flexibility in their content offerings while maintaining the user simplicity of only dealing with a single exploitable content file.

Once an identifier (e.g., URL, text or numeric code, etc.) has been embedded into a copy of the requested content, communications module 240 provides the exploitation copy to an exploitation device (e.g., portable computing device 260) associated with the user who requested ft. In this example, the permissions associated with the identifier embedded into the exploitation copy allow the user to exploit (e.g., view/read) the content on portable computing device 260. In other words, the permissions might specify portable computing device 260 as authorized to exploit the content based on its device ID or serial number, for example. Or perhaps the permissions are broader and allow viewing the content on an entire class of devices, allowing the user to transfer the copy from portable computing device 260 (e.g., a smartphone) to another portable computing device (e.g., a tablet) using NFC (near-field communications), Wi-Fi or other suitable communication protocol between two devices.

In addition to identifying and determining exploitation permissions for different content relative to different exploitation entities, rights management module 220 may upgrade the exploitation permissions for an exploitable content file relative to an exploitation entity in view of an authorized request, In the example above, where the user obtains an exploitation copy of an exploitable content file for use on portable computing device 260, the user may later desire to print the content from the exploitable content file on printer 270. To do this, the user might transfer the exploitation copy (or a copy of the exploitation copy) to printer 270 (e.g. via NFC, Wi-Fi, Bluetooth or other suitable communications protocol). Before exploiting (e.g., printing) the received content, printer 270 accesses the embedded URL for the content and determines whether exploitation is authorized on printer 270 in view of the exploitation permissions. If exploitation is authorized, then printer 270 proceeds to print the content. If not authorized, a message might be displayed or sent to the user asking whether the user would like to upgrade (e.g., via purchase) the exploitation permissions to allow printing on printer 270. If the user indicates the desire to upgrade, this request is communicated to rights management module 220 and the permissions are upgraded (e.g. after charging the user's account or credit/debit card). It should be noted that the amount charged for upgrading the permissions may consider the value of existing permissions, thereby charging the value of all permissions less the value of the existing permissions. In this way, users are given the ability to purchase only the permissions that are relevant to them instead of a lump sum for all permissions (though an aft-permissions option could also be offered, perhaps as a subscription service).

In connection with upgrading exploitation permissions, rights management module 220 updates the permissions at the network address for the embedded URL of the content as issue. For example, if printing permissions are being added, then those printing permissions are updated in the information stored at the URL location for the exploitation copy of the content. Other types of permissions may be included as options in various embodiments, Examples of permissions, include, but are not limited to, printing attributes (e.g., color vs. black and white, printing resolution, etc.), display resolution, audio quality, time constraints (e.g., finite exploitation time vs. unlimited exploitation time), etc.

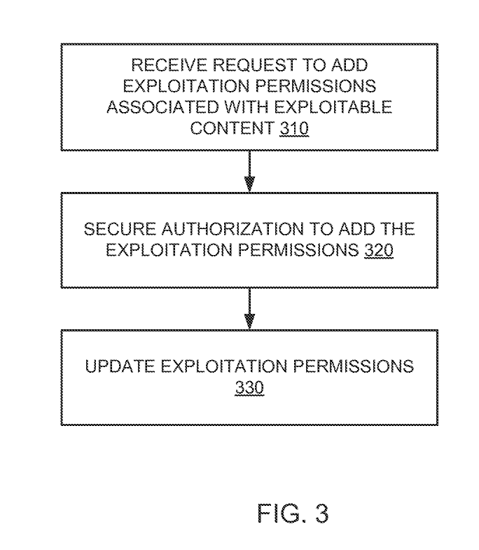

FIG. 3 is a flow diagram of operation in a system according to various embodiments. FIG. 3 includes particular operations and execution order according to certain embodiments. However, in different embodiments, other operations, omitting one or more of the depicted operations, and/or proceeding in other orders of execution may also be used according to teachings described herein.

A system receives 310 a request to add exploitation permissions to existing exploitations permissions associated an exploitable content file relative to an exploitation entity. As discussed above, an exploitation entity can be a single exploitation device, a class of exploitation devices, a user, a group of users, or a group of specific devices associated with a user or group of users. In response to the request, the system secures 320 authorization to add the exploitation permissions. For example, a system may be part of a service that allows users to obtain content for exploitation. The service may allow users to register and store a credit/debit card number with their account or users could purchase content directly without registering. In either case, securing authorization includes obtaining and/or verifying payment for the added exploitation permissions. In some embodiments, authorization could be obtained by other mechanisms, such as paying for content using earned tokens or points (e.g. as part of a customer loyalty program) or simply by obtaining indication of approval from an owner or manager of the content at issue.

The system updates 330 exploitation permissions after securing authorization. In various embodiments, updating exploitation permissions includes updating data and/or information maintained at a URL location to reflect the additional exploitation permissions.

In an example, when a user first selects content (e.g. an image) to download (e.g. for display on a smartphone), a URL is created that points to data/information identifying the permissions for the content. An identifier for the content itself may also be stored at the URL location. The URL is then embedded into an exploitation copy of the content that is sent to the requesting user. Thus, when the user subsequently desires to add permissions for the exploitation copy of the content, the data/information at the URL location is updated to reflect the added permissions (after securing authorization).

Exploitation devices verify exploitation permissions before exploiting content with an embedded exploitation permissions identifier (e.g., URL). Thus, an exploitation copy of content (e.g., an image) can have dynamic exploitation permissions based on the permissions data/information stored at the URL location for the exploitation copy of the content. In other words, different users can obtain different exploitation copies of the same content and the exploitation permissions may be different, depending on the data/information stored at the unique URL for each exploitation copy.

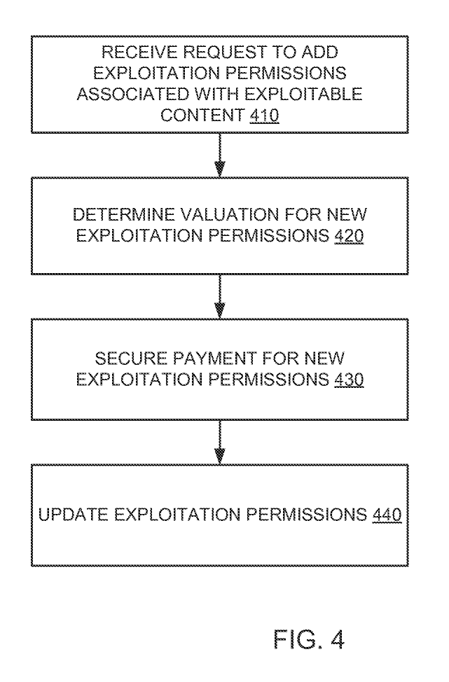

FIG. 4 is a flow diagram of operation in a system according to various embodiments. FIG. 4 includes particular operations and execution order according to certain embodiments. However, in different embodiments, other operations, omitting one or more of the depicted operations, and/or proceeding in other orders of execution may also be used according to teachings described herein.

A system receives 410 a request to add exploitation permissions to existing exploitations permissions associated an exploitable content file relative to an exploitation entity. The system determines 420 the value of the exploitation permissions to be added in view of the valuation of existing exploitation permissions for the exploitation entity. For example, certain existing exploitation permissions may have more value than other exploitation permissions. Also, users may have different combinations of existing exploitation permissions. Accordingly, the system determines the value of the new exploitation permissions in view of these or similar variables.

After determining the value of the requested exploitation permissions, the system secures 430 authorization (e.g., via payment, content owner consent, etc.) to add the exploitation permissions.

Various modifications may be made to the disclosed embodiments and implementations of the invention without departing from their scope. Therefore, the illustrations and examples herein should be construed in an illustrative, and not a restrictive sense.

1. A system, comprising:
a memory to store an exploitable content file;
a rights management module to manage exploitation permissions for the exploitable content file relative to an exploitation entity;
an embedding module to embed an identifier into an exploitation copy of the exploitable content file, the identifier indicating a network address for ascertaining the exploitation permissions; and
a communications module to provide the exploitation copy to an exploitation device.

2. The system of claim 1, further comprising:
the rights management module to upgrade the exploitation permissions for the exploitable content file relative to the exploitation entity in response to an authorized request.

3. The system of claim 1, wherein the exploitation entity comprises one or more exploitation devices associated with a user.

4. The system of claim 1, wherein the exploitation entity comprises a class of exploitation devices.

5. The system of claim 1, wherein the communications module is a near-field communications (NFC) module.

6. A method comprising:
receiving a request to add additional exploitation permissions to existing exploitations permissions associated with an exploitable content file relative to an exploitation entity;
securing authorization to add the additional exploitation permissions; and
updating the exploitation permissions for the exploitation entity, wherein the exploitation permissions are located at a network address indicated by an identifier embedded in the exploitable content file.

7. The method of claim 6, wherein the exploitation permissions include printing permissions.

8. The method of claim 6, wherein securing authorization comprises:
determining a valuation of the exploitation permissions to be added based at least in part on the valuation of existing exploitation permissions for the exploitation entity; and
securing payment for the exploitation permissions to be added in view of the valuation of the exploitation permissions to be added.

9. The method of claim 6, wherein the exploitation entity comprises one or more exploitation devices associated with a user.

10. The method of claim 6, wherein the exploitation entity comprises a class of exploitation devices.

11. A non-transitory computer-readable storage medium having instructions that, when executed, cause a computer to:
store an exploitable content file;
store exploitation permissions for the exploitable content file relative to an exploitation entity;
embed an identifier into an exploitation copy of the exploitable content file, the identifier indicating a network address to access the exploitation permissions;
provide the exploitation copy to an exploitation device;
receive a request to add additional exploitation permissions to existing exploitations permissions associated with the exploitable content file relative to an exploitation entity;
secure authorization to add the additional exploitation permissions; and
update the exploitation permissions for the exploitation entity, wherein the exploitation permissions are located at a network address indicated by an identifier embedded in the exploitable content file.

12. The non-transitory computer-readable storage medium of claim 11, wherein the exploitation permissions describe printing permissions.

13. The non-transitory computer-readable storage medium of claim 11, wherein the instructions that cause the securing of authorization comprise further instructions that cause the computer to:
determine a value of the exploitation permissions to be added based at least in view of the valuation of existing exploitation permissions for the exploitation entity; and
confirm payment for the exploitation permissions to be added in view of the valuation of the exploitation permissions to be added.

14. The non-transitory computer-readable storage medium of claim 11, wherein the exploitation entity comprises one or more exploitation devices associated with a user.

15. The non-transitory computer-readable storage medium of claim 11, wherein the exploitation entity comprises a class of exploitation devices.
